(19) United States
(12) Patent Application Publication
(10) Pub. No.: US 2013/0109876 A1
(43) Pub. Date: May 2, 2013

(54) PROCESS FOR THE PREPARATION OF ORGANOZINC HALIDES

(71) Applicant: BASF SE, Ludwigshafen (DE)

(72) Inventors: Stefan Pichlmair, Evans City, PA (US); Joachim Schmidt-Leithoff, Freiburg (DE)

(73) Assignee: BASF SE, Ludwigshafen (DE)

(21) Appl. No.: 13/661,811

(22) Filed: Oct. 26, 2012

Related U.S. Application Data
(60) Provisional application No. 61/553,272, filed on Oct. 31, 2011.

(51) Int. Cl. C07F 3/06

(52) U.S. Cl. 556/128

(57) ABSTRACT

The present invention relates to a process for the preparation of organozinc halides with low residual alkyl or aryl halide content.

### FIELD OF THE INVENTION

The present invention relates to a process for the preparation of organozinc halides with low residual alkyl or aryl halide content.

### BACKGROUND OF THE INVENTION

Cross coupling techniques according to Suzuki or Negishi are valuable tools for modern organic syntheses. Both technologies enable convergent synthesis of complex pharmaceutical intermediates from readily available building blocks, such as boronic acids (Suzuki) or organozinc intermediates (Negishi) with corresponding organic halides. Despite the widespread use of boronic acids, accessing functionalized boronic acids, i.e. boronic acids containing electrophilic groups such as esters, nitriles or amids is not as trivial. Manufacturing processes for boronic acids typically involve the reaction of Grignard or alkyllithium reagents which are incompatible with electrophilic groups. In contrast, organozinc intermediates used for Negishi coupling are made from organic halides in the presence of metallic zinc. According to literature, the resulting organozinc halide will not react with many functional groups that might be present (P. Knochel, R. D. Singer, Chem. Rev. 1993, Vol. 93, pages 2117 to 2188). Direct oxidative insertion of zinc metal into the carbon-halide bond of organic halides is the most attractive and simplest method for the preparation of functionalized organozinc halides.

The formation of organozinc halides from organic halides requires an activated form of metallic zinc. Zinc metal is typically coated with a passivating layer of zinc oxide which needs to be removed or zinc metal with high surface activity has to be generated in-situ prior to use.

Known zinc activation methods include the Rieke® technology, where an active zinc metal is formed by a redox reaction between zinc chloride and lithium metal in presence of catalytic amounts of an electron carrier such as naphthalene (WO 93/15086). This method allows the synthesis of highly active zinc metal which enables reactions with unreactive organic bromides such as cyclopropyl bromide or ethyl bromide. The high activity of this metal can be explained by the absence of passivating zinc oxide on the metal surface. A major drawback of this technology is that active zinc needs to be prepared on-scale as a zinc slurry in THF prior to the organozinc halide formation reaction. Furthermore, it is very difficult to dose zinc metal slurries at 5 to 15 w % in organic solvents on scale, because the Rieke® zinc settles extremely fast which makes it almost impossible to charge the reactor with the right amounts of Rieke® zinc. As a consequence, Rieke® zinc needs to be prepared in the same reactor prior to the conversion with the organic halide. In an ideal manufacturing setting, it should be possible to stockpile active zinc raw material instead of preparing it freshly on small scale in order to minimize the reactor space. It is known that metal slurries have the tendency to settle fast while being transferred from one vessel to another. As a result, lines can be plugged by accumulating zinc metal, which causes the need of disassembling transfer lines. Rieke® zinc has been found to be pyrophoric in nature when placed on a filter paper while exposed to air. The pyrophoricity of active zinc slurry in presence of flammable THF solvent is a major concern during breaking of transfer lines and poses a tremendous safety hazards for plant operators.

Other methods to prepare organozinc halides employ alkali or alkali earth metals where a reactive organomeallic reagent such as a Grignard or organolithium compound is formed in-situ in the presence of zinc chloride, forming an organozinc compound (P. Knochel et al., Chem. Commun. 2008, Pages 5824 to 5826; P. Knochel et al., Angew. Chem. Int. Ed. 2008, vol. 47, pages 6802 to 6806).

Several other methods were developed for the oxidative zinc insertion reaction from commercial zinc powder in THF (P. Knochel et al., Angew. Chem. Int. Ed. 2006, vol. 45, pages 6040 to 6044; WO2007/113294; P. Knochel, C. Jubert, J. Org. Chem. 1992, vol. 57, pages 5425 to 5431). These methods provide solutions for alkyl and aryl iodides, certain electron poor aryl bromides, and certain types of alkyl bromides. Some alkyl bromides cannot be converted by oxidative zinc insertion (i.e. cyclopropyl bromide) while certain alkyl and aryl bromides show incomplete reaction after extended heating which makes the method impractical for being used in a manufacturing process. Alkyl chlorides are typically unreactive when using commercial zinc powder as raw material and generally cannot be used for large scale oxidative zinc insertion.

The most preferred method would be to react organic halides directly with commercially available zinc because it is more convenient and atom economic than the methods mentioned above.

Sometimes reactions between an organic halide and zinc metal stop at a conversion rate around 90% or even lower, leaving unreacted organic halide in the reaction mixture. Presence of unreacted halide in organozinc halide solutions is a concern, since subsequent transition metal catalyzed cross-coupling (i.e. Negishi coupling) will lead to homocoupling byproduct formation, which is highly undesired. This sidereaction is especially pronounced if the reaction rate between the organic halide contaminant and organozinc halide product exceeds the reaction rate of the intended halide coupling partner and the organozinc halide product.

Rieke® zinc was used in combination with a two fold excess of potassium iodide to convert ethyl chlorobutylate to the corresponding organozinc chloride at 65° C. (R. Rieke et al., J. Org. Chem. 1991, vol. 56, pages 1445 to 1453). This procedure is not practical because highly active Rieke® zinc is needed along with excess of potassium iodide.

Several methods to activate zinc metal directly by means of an oxidative zinc insertion reaction from commercial available zinc are known which are described in very polar solvents such as DMPU, dimethylacetamide (DMA), dimethylsulfoxide (DMSO), N-methylpyrrolidone (NMP) or DME (K. Tagiki et al., Chem. Lett. 1993, pages 469 to 472; K. Tagiki et al., Chem. Lett. 1994, pages 2055 to 2058; M. Gosmini et al. ; Synlett. 2005, pages 2171 to 2174; I. Kazmierski et al., Tetrahedron Lett. 2003, vol. 44, pages 6417 to 6420). Furthermore, iodine was employed in combination with polar solvents (S. Huo, Org. Lett. 2003, vol. 5, pages 423 to 425). However, when a more suitable solvent such as THF was used the reaction of e. g. 1-(bromomethyl)-3,4-(methylenedioxy)benzene with zinc dust was unsuccessful yielding only the corresponding homocoupling product.

It is known that addition of small amounts of iodine (I₂) increases zinc surface activity and allows zinc insertion reactions of alkyl bromides in very polar organic solvents such as DMPU, DMA, DMSO, NMP or DME. The disadvantage of this method is that iodine is corrosive causing pitting to stainless steel and can damage the stainless steel equipment in a manufacturing setting even in low amounts (B. D. Craig, D. S. Anderson, Handbook of corrosion data. ASM international, 2^{nd} edition, 1995, page 483). Furthermore, it is not desirable to use the above mentioned solvents due to their toxicity, costs, possible waste disposal problems and potential disturbing properties during subsequent Negishi coupling reactions. Typically, ethereal solvents are preferred for organozinc intermediates due to their broad commercial availability, low health concern, environmental tolerance and successful cross coupling characteristic in Negishi coupling reactions as well as ease of handling in industrial applications.

Tagaki et al. describe the use of polar solvent systems to convert aryl bromides in the presence of potassium iodide, catalytic amounts of nickel chloride and zinc to form biaryl compounds. The author suspects the presence of arylzinc bromide intermediates which can undergo homocoupling in the presence of catalytic amounts of nickel (K. Tagaki et al, Bull. Chem. Soc. Jpn. 1980, vol. 53, pages 3691 to 3695).

For the preparation of organozinc halides on a commercial scale it is desirable to use THF as solvent in combination with customary zinc metal. Unfortunately, THF is a rather non-polar solvent compared to the polar solvents mentioned above and special activation methods need to be employed to prepare organozinc halides. The success of an oxidative zinc insertion often depends on substrate reactivity. For example, Reformatsky reagents can be made from alpha-halo esters without any activation of the commercial zinc powder (M. S. Newman, J. Am. Chem. Soc. 1942, vol. 64, pages 2131 to 2133). Other reactive substrates can be alkyl iodides, esters with halide groups alpha to the carbonyl group and benzyl chlorides. Unfortunately, iodides are not always readily available on a commercial scale. Alkyl and aryl bromides and chlorides are usually less reactive to normal zinc insertion and require the use of highly reactive zinc to achieve oxidative insertion (R. Rieke et al., J. Am. Chem. Soc. 1999, vol. 121, pages 4155 to 4167).

The problem of not being able to use THF as the solvent was also mentioned by Tagiki et al (K. Tagiki et al., J. Org. Chem., 2003, vol. 68, pages 2195 to 2199). Lack of reactivity between zinc powder and alkyl halides in ethereal solvents was addressed by carrying out reactions at elevated temperatures up to 180° C. in triglyme and with aryl iodides only. In some cases even aryl iodides showed slow reaction rates. It is generally known that high temperatures are not suitable for large scale manufacturing in a multipurpose plant using batch processes. Heat-up times may also cause a significantly delay in the manufacturing process which increases costs and lowers reactor throughput.

Nucleophilic S_{N}2 replacement reactions between alkali metal halide salts and alkyl halides are known transformations where, for example, an alkyl bromide is converted with sodium iodide to form the corresponding alkyl iodide while precipitating sodium bromide as a byproduct. To drive the equilibrium to completion several equivalents of the alkali metal salt are used and a solvent where the alkali metal byproduct is insoluble. In the past acetone was chosen as a suitable solvent, because the byproduct is usually not soluble in the solvent, hence the reaction is shifted to the product side. Alcohols are also used frequently for this reaction. Using acetone or alcohols for a one-pot organozinc halide formation is not applicable because the zinc reagent will react with the solvent especially at elevated temperatures. Most suitable solvents for preparing organozinc halides are ethereal solvents, most preferably THF, where they are stable for extended time.

It is generally known that sodium or potassium iodides are poorly soluble in ethereal solvents. To enhance solubility, chelating additives such as 1,2-dimethoxyethane, diethylene glycol dimethyl ether, triethylene glycol dimethyl ether or crown ethers such as 12-crown-4, 15-crown-5 and 18-crown-6 can be used to chelate the metal cation such as lithium, sodium and potassium for enhancing solubility. The ethereal additive has the advantage that it does increase the solubility of the iodide, but it does not interfere with the organometallic reagent formed in the process.

Reaction conditions where aryl bromides and copper iodide in combination with diamine ligands were described for halide exchange reactions to prepare aryl iodides (S. L. Buchwald et al., J. Am. Chem. Soc. 2002, vol. 124, pages 14844 to 14845). The reactions were carried out in high boiling solvents like xylene/diglyme mixtures, n-butanole, dioxane or dimethylformamide (DMF) in combination with chelating additives. For industrial applications solvent mixtures are not preferred.

There is no procedure reported which was carried out in less polar solvents such as THF and where this technique was employed to further produce organozinc halides.

### SUMMARY OF THE INVENTION

It was an object of the present invention to provide a process for the preparation of organozinc halides with low residual alkyl or aryl halide content. Customary zinc metal should be employed to facilitate large scale application of the new process.

Accordingly, a new process for the preparation of organozinc halides with low residual alkyl or aryl halide content has been found, comprising the step of reacting zinc metal with an organic chloride or bromide in the presence of an iodide salt in a non-polar solvent.

### DETAILED DESCRIPTION OF THE INVENTION

One embodiment of the present invention is a process for the preparation of organozinc halides, comprising the step of reacting zinc metal with an organic chloride or bromide in the presence of an iodide salt in a non-polar solvent.

According to the invention zinc metal can be any customary zinc metal, e.g. in the form of powder, turnings, chips, flakes or the like.

In a preferred embodiment of the present invention the zinc metal can be activated prior to its use in the process according to the invention by conventional methods, e.g. by etching its surface with trimethylsilyl chloride, dibromoethane, halides or the like.

As used in connection with the present invention, the term “organic chlorides or bromides” denotes a compound of the general formula R—X wherein X is Cl or Br and R is an organic group comprising at least one carbon atom directly bonded to X, that may contain one or more heteroatoms like hydrogen, oxygen, nitrogen, sulphur, phosphorus, fluorine, chlorine, bromine, iodine, boron, silicon or selenium. The organic group can have any linear or cyclic, branched or unbranched, mono- or polycyclic, carbo- or heterocyclic, saturated or unsaturated molecular structure and may comprise protected or unprotected functional groups like ester, amide, nitrile, alkoxy, carbonyl, etc.Furthermore, the organic group may be linked to or part of an oligomer or polymer with a molecular weight up to one million Dalton.

Preferred organic chlorides or bromides that can be employed in the process according to the invention are compounds of the general formula R—X as above, wherein R is an C₁-C₂₄ alkyl, C₃-C₁₆ cycloalkyl, C₆-C₁₄ aryl, C₇-C₂₄ alkaryl, C₇-C₂₄ aralkyl or C₃-C₁₄ heteroaryl group, in which one or more hydrogen atoms may be replaced by protected or unprotected functional groups like ester, amide, nitrile, alkoxy, carbonyl, etc.

As used in connection with the present invention, the term “C₁-C₂₄ alkyl” denotes a branched or an unbranched saturated hydrocarbon group comprising between 1 and 24 carbon atoms; examples are methyl, ethyl, propyl, isopropyl, butyl, isobutyl, sec-butyl, tert-butyl, amyl, isoamyl, sec-amyl, 1,2-dimethylpropyl, 1,1-dimethylpropyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and isopinocampheyl. Preferred are the alkyl groups methyl, ethyl, propyl, isopropyl, n-butyl, isobutyl, sec-butyl, tert-butyl, amyl, isoamyl, sec-amyl, 1,2-dimethylpropyl, 1,1-dimethylpropyl, hexyl and octyl.

The term “C₃-C₁₆ cycloalkyl” denotes a saturated hydrocarbon group comprising between 3 and 16 carbon atoms including a mono- or polycyclic structural moiety. Examples are cyclopropyl, cyclobutyl, cyclopentyl, cyclohexyl, cycloheptyl, cyclooctyl, cyclononyl or cyclodecyl. Preferred are the cycloalkyl groups cyclopropyl, cyclopentyl and cyclohexyl.

The term “C₆-C₁₄ aryl” denotes an unsaturated hydrocarbon group comprising between 6 and 14 carbon atoms including at least one aromatic ring system like phenyl or naphthyl or any other aromatic ring system.

The term “C₇-C₂₄ aralkyl” denotes an aryl-substituted alkyl group comprising between 7 and 24 carbon atoms including for example a phenyl-, naphthyl- or alkyl-substituted phenyl- or alkyl-substituted naphthyl-group or any other aromatic ring system. Examples of aralkyl groups include benzyl, 1- or 2-phenylethyl, 1-, 2- or 3-phenylpropyl, mesityl and 2-, 3- or 4-methylbenzyl groups.

The term “C₇-C₂₄ alkaryl” denotes an alkyl-substituted aryl group comprising between 7 and 24 carbon atoms including for example a phenyl- or naphthyl- or alkyl-substituted phenyl- or alkyl-substituted naphthyl-group or any other aromatic ring system and an alkyl substituent as defined above. Examples for alkaryl groups are 2,- 3- or 4-methylphenyl, 2,- 3- or 4-ethylphenyl and 2,- 3-, 4-, 5-, 6-, 7- or 8-methyl-1-naphthyl groups. ortho-C₆H₃alkyl denotes an alkyl-substituted divalent aryl group occurring in catechol-type derivatives.

The term “C₃-C₁₄ heteroaryl” denotes a mono- or polycyclic aromatic ring system comprising between 3 and 14 ring atoms, in which at least one of the ring carbon atoms is replaced by a heteroatom like nitrogen, oxygen or sulfur. Examples are pyridyl, pyranyl, thiopyranyl, chinolinyl, isochinolinyl, acridyl, pyridazinyl, pyrimidyl, pyrazinyl, phenazinyl, triazinyl, pyrrolyl, furanyl, thiophenyl, indolyl, isoindolyl, pyrazolyl, imidazolyl, oxazolyl, isoxazolyl, thiazolyl, isothiazolyl and triazolyl.

Suitable iodide salts for the process according to the invention are e. g. tetraalkylammonium iodides of the general formula R₄N+I—, wherein R is methyl, ethyl, n-propyl, isopropyl, n-butyl, sec-butyl, isobutyl or phenyl, lithium, sodium or potassium iodide (LiI, NaI or KI). In a preferred embodiment of the present invention the iodide salt is readily soluble in the employed solvent at elevated temperatures but poorly soluble at ambient temperature or below.

In one embodiment of the present invention the iodide salt is employed in stoichiometric amounts relative to the organic chloride or bromide. In a preferred embodiment the iodide salt is employed only in catalytic amounts, i. e. in amounts of from about 0.01 to about 0.5 mol, preferable from about 0.05 to about 0.3 mol relative to 1 mol of organic chloride or bromide.

In one embodiment of the present invention the iodide salt is added to the reaction mixture at the beginning of the reaction. In another embodiment of the present invention the iodide salt is added to the reaction mixture after the formation of the organozinc compound has already been initiated.

According to the invention the process for the preparation of organozinc halides has to be carried out in a non-polar solvent. Suitable solvents are for example ethers like diethylether, tetrahydrofurane (THF), 2-methyl-THF, methyl-tert.-butylether (MTBE), diisopropylether, or hydrocarbons like hexanes, pentane, benzene, toluene, xylenes and the like and mixtures thereof. Preferred solvents are THF, 2-methyl-THF and MTBE.

In a preferred embodiment of the present invention the process for the preparation of organozinc halides has to be carried out at elevated temperature, preferable at a temperature in the range of from 30° C. to 150° C., most preferable in the range of from 40° C. to 130° C. The reaction temperature may be well above the boiling point of the employed solvent in which cases the process has to be carried out under increased pressure.

In a preferred embodiment of the present invention the process can optionally be carried out in the presence of chelating additives like e. g. diaminopropane, diglyme and the like which enable and accelerate the oxidative insertion reaction of zinc into alkyl halides to result in organozinc halides.

Furthermore, the process can optionally be carried out in the presence of catalytic amounts of copper iodide and/or lithium chloride.

The present invention is further illustrated by the following examples without limitation to the same.

### EXAMPLES

### 1. Ethylbromide

### Experiment 1 (Comparative, Poor Conversion Without Iodide Source at 60° C.)

Zinc metal powder (4.90 g, 0.075 mol, 1.5 eq.) and lithium chloride (LiCl, 2.11 g, 0.05 mol, 1 eq.) were suspended in 40 ml THF and stirred vigorously for 0.5 h. Then the mixture was heated to 60° C., trimethylsilyl chloride (TMSCl) (0.27 g, 2.5 mmol, 0.05 eq.) was added and stirred thoroughly with the zinc-lithium chloride slurry. Bromoethane (5.45 g, 0.05 mol, 1 eq.) was injected and the reaction was heated to 60° C. and monitored by GC analysis. After 18 h, 91% conversion of the bromoethane was detected.

### Experiment 2 (With Catalytic Amounts of tetrabutylammoninum iodide)

In addition to the procedure described in Experiment 1 tetrabutylammonium iodide (5.57 g, 0.015 mol, 0.3 eq.) was added to the reaction mixture after the addition of TMSCl. The resulting mixture was heated to 60° C. and monitored by GC analysis. After 3 h, 50% and after 6 h, 99.5% conversion of the bromoethane was detected. The reaction showed 100% completion after 18 h.

### Experiment 3 (With Catalytic Amounts of tetramethylammonium iodide)

In addition to the procedure described in Experiment 1 tetramethylammonium iodide (3.06 g, 0.015 mol, 0.3 eq.) was added to the reaction mixture after the addition of TMSCl. The resulting mixture was heated to 60° C. and monitored by GC analysis. After 3 h, 50% and after 6 h 96.9% conversion of the bromoethane was detected. The reaction showed 100% completion after 18 h.

### Experiment 4 (With Reduced Catalytic Amounts of tetrabutylammonium iodide)

In addition to the procedure described in Experiment 1 tetrabutylammonium iodide (1.84 g, 5.0 mmol, 0.1 eq.) was added to the reaction mixture after the addition of TMSCl. The resulting mixture was heated to 60° C. and monitored by GC analysis. The reaction showed 97.6% completion after 6 h and 99.9% completion after 18 h.

### 2. Butylchloride

### Experiment 5 (Comparative, Poor Conversion Without Iodide Source at 60° C.)

Zinc metal powder (4.90 g, 0.025 mol, 1.5 eq.) and LiCl (2.11 g, 0.05 mol, 1 eq.) were suspended in THF (40 ml) under inert atmosphere and stirring was continued for 0.5 h. TMSCl (0.27 g, 2.5 mol, 0.05 eq.) was added followed by butyl chloride (4.63 g, 0.050 mol, 1.0 eq.) and heating to 60° C. The reaction was heated for 18 h after which 5% conversion was observed.

### Experiment 6 (With Stoichiometric Amounts of tetrabutylammoninum iodide)

In addition to the procedure described in Experiment 5 tetrabutylammonium iodide (18.46 g, 0.050 mol, 1 eq.) was added to the reaction mixture after the addition of TMSCl. The resulting mixture was heated to 60° C. and monitored by GC analysis. The reaction showed 98.1% completion after 18 h.

### Experiment 7 (With Catalytic Amounts of tetrabutylammoninum iodide)

In addition to the procedure described in Experiment 5 tetrabutylammonium iodide (1.85 g, 5.0 mmol, 0.1 eq.) was added to the reaction mixture after the addition of TMSCl. The resulting mixture was heated to 60° C. and monitored by GC analysis. The reaction showed 70.3% completion after 18 h.

### Experiment 8 (With Stoichiometric Amounts of sodium iodide)

In addition to the procedure described in Experiment 5 sodium iodide (NaI, 7.49 g, 0.050 mol, 1 eq.) and dimethoxyethane (6.7 g, 0.05 mol, 1 eq.) were added to the reaction mixture after the addition of TMSCl. The resulting mixture was heated to 60° C. and monitored by GC analysis. The reaction showed 87% completion after 18 h.

### Experiment 9 (With Stoichiometric Amounts of potassium iodide)

In addition to the procedure described in Experiment 5 potassium iodide (KI, 16.6 g, 0.1 mol, 2 eq.) was added to the reaction mixture after the addition of TMSCl. The resulting mixture was heated to 60° C. and monitored by GC analysis. The reaction showed 98% completion after 18 h.

### 3. Neopentylbromide

### Experiment 10 (Comparative, Poor Conversion Without Iodide Source at 65° C.)

Zinc metal powder (6.0 g, 0.092 mol, 1.5 eq.) and lithium chloride (2.59 g, 0.061 mol, 1 eq.) were suspended in THF (43 ml). TMSCl was added (0.10 g, 0.92 mmol, 0.015 eq.) to activate the zinc powder. After five minutes neopentyl bromide (9.21 g, 0.061 mol, 1 eq.) was added and the reaction was heated to 65° C. and monitored by GC. After 18 h only 31.8% conversion was observed based on GC analysis. The reaction did not progress after extended heating.

### Experiment 11 (Comparative, Poor Conversion Without Iodide Source Even at 100° C.)

Zinc metal powder (24.0 g, 0.37 mol, 1.5 eq.) and lithium chloride (10.4 g, 0.24 mol, 1 eq.) were charged into a Fisher Porter bottle and THF (172 g) was added. TMSCl (0.40 g, 3.6 mmol, 0.05 eq.) was added and the mixture was stirred for several minutes. Then, neopentyl bromide (36.2 g, 0.24 mol, 1 eq.) was added. The Fisher Porter bottle was equipped with a back-pressure regulator and heated to 100° C. After 18 h 47.1% conversion was detected. The reaction did not progress after prolonged heating.

### Experiment 12 (With Catalytic Amounts of tetrabutylammoninum iodide)

Zinc metal powder (4.90 g, 0.075 mol, 1.5 eq.), lithium chloride (2.11 g, 0.05 mol, 1 eq.), tetrabutylammonium iodide (5.54 g, 0.015 mol, 0.3 eq.) and THF (40 ml) were suspended. The suspension was heated to 50° C. and TMSCl (0.27 g, 2.5 mmol, 0.05 eq.) was added. Five minutes later neopentyl bromide (7.55 g, 0.05 mol, 1.0 eq.) was added at once. The reaction mixture was heated to 60° C. and the conversion was monitored over time by GC analysis. The reaction went to 65% completion after 18 h. Continuous heating gave 97% completion after 64 h.

### 4. Cyclopropylbromide

### Experiment 13 (Comparative, Poor Conversion Without Iodide Source at 65° C.)

Zinc metal powder (7.37 g, 0.1127 mol) and lithium chloride (3.2 g, 0.0755 mol) were suspended in 65 ml THF. Then, dibromomethane (1.10 g, 5.85 mmol) was added followed by TMSCl (0.12 g, 1.1 mol). The reaction mixture was heated to 65° C. and cyclopropylbromide was added. The mixture was heated for 20 h while monitoring the conversion by GC. Less than 1% conversion was observed.

### Experiment 14 (With Catalytic Amounts of tetrabutylammoninum iodide)

A 1 L pressure reactor was charged with THF (220 g), lithium chloride (7.63 g, 0.18 mol, 1.0 eq.) and zinc metal powder (17.7 g, 0.27 mol, 1.5 eq.) under inert atmosphere. TMSCl (0.59 g, 5.4 mol, 0.03 eq.) was added at 21° C. to the suspension and stirred for five minutes followed by adding cyclopropylbromide (21.7 g, 0.18 mol, 1 eq.) and a slurry of tetrabutylammonium iodide (19.95 g, 0.054 mol, 0.3 eq.) in THF. The reactor was sealed, pressurized to 1.4 bar nitrogen pressure and heated to 130° C. and the conversion was monitored by GC. After 18 h already 53% of conversion was detected while detecting absence of any homo-coupling product by GC. The reaction kept progressing and showed complete conversion after 64 h.

### Experiment 15 (Comparative, Poor Conversion Without Iodide Source Even at 130° C.)

A 1 L pressure reactor was charged with THF (12 ml), lithium chloride (0.41 g, 9.76 mmol, 1.0 eq.) and zinc powder (0.96 g, 14.6 mmol, 1.5 eq.) under inert atmosphere. The mixture was heated to 50° C. and TMSCl (0.05 g, 0.45 mmol, 0.03 eq.) was added to the suspension and stirred for five minutes before cyclopropylbromide (1.18 g, 9.8 mmol) was added. The reactor was sealed and heated to 130° C. The conversion was monitored by GC. After 18 h, 70% conversion and absence of homo-coupling product by GC was detected. The conversion was unchanged after 42 h of heating.

### 5. 3-Bromoanisol

### Experiment 16 (Comparative, Poor Conversion Without Iodide Source Even at 130° C.)

Zinc metal powder (17.65 g, 0.27 mol) was suspended in THF (162 ml), LiCl (7.63 g, 0.18 mol), TMSCl (0.98 g, 0.98 mol), dibromoethane (3.38 g, 0.018 mol) and 3-bromoanisol (33.7 g, 0.18 mol) were added and the mixture was heated to 130° C. over night in a pressure reactor and analyzed by GC. The reaction showed 6% conversion to the corresponding organozinc bromide.

### Experiment 17 (With Stoichiometric Amounts of Sodium iodide in Presence of Cul and Diaminopropane at 130° C.)

To the reaction mixture in experiment 16, sodium iodide (2 eq.), Cul (0.05 eq.), diaminopropane (0.15 eq.) and diglyme (10 w % target concentration) was added. The reaction showed 49% conversion after 18 h heating to 130° C. and 69% conversion after 42 h.

### 6. 2-Bromopyridine

### Experiment 18 (Comparative, Poor Conversion Without Iodide Source Even at 130° C.)

Zinc metal powder (0.96 g, 0.015 mol) was suspended in THF (12 ml), LiCl (0.413, 9.8 mmol) and TMSCl (0.05 g, 4.6 mmol) were added and the reaction mixture was stirred for 5 min. Then 2-bromopyridine (1.58 g, 0.01 mol) was added, the mixture was heated to 130° C. over night in a pressure reactor and analyzed by GC. The reaction showed 41% conversion to the corresponding pyridinezinc bromide as well as 26% unreacted 2-bromopyridine and 33% bi-pyridine.

### Experiment 19 (With Stoichiometric Amounts of Sodium Iodide in Presence of Cul and Diaminopropane at 130° C.)

Cul (0.142 g, 0.75 mmol), NaI (4.49 g, 30 mmol) was suspended in 10 w % diglyme/THF (12.2 ml) and diaminopropane (0.11 g, 1.5 mmol) and 2-bromopyridine (2.80 g, 15 mmol) was added. The mixture was heated in a pressure reactor to 130° C. for 18 h and analyzed by GC. The reaction showed 98.5% conversion to 2-iodopyridine. Zinc (3.43 g, 52.5 mmol), LiCl (1.48 g, 35 mmol) and TMSCl (0.19 g, 1.75 mmol) were mixed in THF (8.8 g) and the above mixture containing the 2-iodopyridine was added. The reaction was heated to 130° C. and analyzed by GC after 18 h. 100% conversion to the corresponding pyridinezinc species was observed by GC.

1-8. (canceled)

9. A process for the preparation of organozinc halides, comprising the step of reacting zinc metal with an organic chloride or bromide in the presence of an iodide salt in a non-polar solvent.

10. The process according to claim 9, wherein the organic chloride or bromide is a compound of the general formula R—X wherein X is Cl or Br and R is a C₁-C₂₄ alkyl, C₃-C₁₆ cycloalkyl, C₆-C₁₄ aryl, C₇-C₂₄ alkaryl, C₇-C₂₄ aralkyl or C₃-C₁₄ heteroaryl group, in which one or more hydrogen atoms may be replaced by a protected or unprotected functional group selected from the group consisting of ester, nitrile, alkoxy and carbonyl.

11. The process according to claim 9, wherein the iodide salt is a tetraalkylammonium iodide of the general formula R₄N⁺I⁻, wherein R is methyl, ethyl, n-propyl, isopropyl, n-butyl, sec-butyl, isobutyl or phenyl, lithium, sodium or potassium iodide.

12. The process according to claim 10, wherein the iodide salt is a tetraalkylammonium iodide of the general formula R₄N⁺I⁻, wherein R is methyl, ethyl, n-propyl, isopropyl, n-butyl, sec-butyl, isobutyl or phenyl, lithium, sodium or potassium iodide.

13. The process according to claim 11, wherein the iodide salt is employed in amounts of from about 0.01 to about 0.5 mol relative to 1 mol of organic chloride or bromide.

14. The process according to claim 12, wherein the iodide salt is employed in amounts of from about 0.01 to about 0.5 mol relative to 1 mol of organic chloride or bromide.

15. The process according to claim 9, wherein the non-polar solvent is diethylether, tetrahydrofurane (THF), 2-methyl-THF, methyl-tert.-butylether, diisopropylether, hexanes, pentane, benzene, toluene, xylenes or mixtures thereof.

16. The process according to claim 14, wherein the non-polar solvent is diethylether, tetrahydrofurane (THF), 2-methyl-THF, methyl-tert.-butylether, diisopropylether, hexanes, pentane, benzene, toluene, xylenes or mixtures thereof.

17. The process according to claim 9, wherein the process is carried out at a temperature in the range of from 30° C. to 150° C.

18. The process according to claim 16, wherein the process is carried out at a temperature in the range of from 30° C. to 150° C.

19. The process according to claim 9, wherein in the process is carried out in the presence of a chelating additive.

20. The process according to claim 18, wherein the process is carried out in the presence of a chelating additive.

21. The process according to claim 9, wherein the process is carried out in the presence of catalytic amounts of copper iodide and/or lithium chloride.

22. The process according to claim 20, wherein the process is carried out in the presence of catalytic amounts of copper iodide and/or lithium chloride.
